(19) United States
(12) Patent Application Publication
(10) Pub. No.: US 2016/0321039 A1
(43) Pub. Date: Nov. 3, 2016

(54) TECHNOLOGY MAPPING ONTO CODE FRAGMENTS

(71) Applicant: Wave Computing, Inc., Campbell, CA (US)

(72) Inventors: Samit Chaudhuri, Cupertino, CA (US); Andrew William Fox, Santa Cruz, CA (US); Tigran Sargsyan, Yerevan (AM)

(21) Appl. No.: 15/142,595

(22) Filed: Apr. 29, 2016

Related U.S. Application Data
(60) Provisional application No. 62/154,364, filed on Apr. 29, 2015.

(51) Int. Cl. G06F 9/44; G06F 3/06

(52) U.S. Cl. CPC G06F 8/315; G06F 3/0604; G06F 3/0629; G06F 3/0673

(57) ABSTRACT

Technology mapping onto code fragments and related concepts are disclosed. Program descriptions are obtained in a high-level language. One or more intrinsic libraries containing modules are obtained. The modules correspond to sections of code intended for execution on the special purpose hardware. The high-level program description is analyzed to determine locations of one or more cuts within the program. The cuts represent portions of the high-level code that are eligible for replacement by one or more modules from intrinsic libraries. A matching process is used to find modules that are suitable replacements for the high level code. Once the replacements are made, additional verification and/or validation are performed by compiler checking and/or execution tests.

### RELATED APPLICATIONS

This application claims the benefit of U.S. provisional patent application “Technology Mapping onto Code Fragments” Ser. No. 62/154,364, filed Apr. 29, 2015. The foregoing application is hereby incorporated by reference in its entirety.

### FIELD OF ART

This application relates generally to coding and more particularly to technology mapping onto code fragments.

### BACKGROUND

Modern integrated circuits or chips are highly complex designs that are used for a variety of systems and/or applications such as communications, computing, and consumer electronics, among many others. Various chips for functions like control, computing, and storage are placed into the systems, and the systems are then programmed in order to customize system function to their intended applications. The programming tasks are themselves complex and must be undertaken in such a way that the resulting systems are effective, efficient, and economically viable.

Chips can include processors having a variety of architectures. The processors can be capable of executing instructions such as reading data from registers and/or memory, writing data to registers and/or memory, and basic arithmetic and logic functions. The processors may perform various operational tasks such as instruction fetch, instruction decode, instruction execution, and data transfer to/from registers and memory. Input and output (I/O) can be implemented as memory or register locations so that external hardware and peripherals can be controlled and/or monitored. Processors may operate in a pipelined manner, where one instruction is being executed while a future instruction is being fetched. Furthermore, some processors may include multiple cores, where each core is operating on an instruction set. Thus, modern integrated circuits can perform multiple operations simultaneously.

In addition, coprocessors can be used to complement the functionality of the main processors. Coprocessors can offload a main processor of compute-intensive tasks such as floating point arithmetic operations. Other coprocessors may assist in performing graphics operations such as bit block transfer operations. In some cases, the coprocessors may operate as a slave to the main processor, as the coprocessors may act under control of the main processors. Communication between the main processor and coprocessor may be implemented via a communication bus. This allows the main processor to dispatch appropriate tasks to coprocessors.

Systems may further include digital signal processors (DSPs). The DSPs may be specifically designed for the processing of analog signals. Such processing may include filtering, compressing, amplifying, and/or scrambling the signals. Often, DSPs may perform numerous mathematical operations in a cost-reduced and/or power-saving integrated circuit design. A modern system-on-chip (SoC) may implement multiple processors, coprocessors, and/or digital signal processors within a single integrated circuit package. Furthermore, SoCs may include interfaces for standards such as USB, Ethernet, and the like.

Software is often developed in order to control the operation of such complex systems involving processors, coprocessors, and/or DSPs. Software control allows complex systems to be reconfigured for different tasks and applications. A compiler is a key part of the software development toolchain. Compilers allow logical instructions to be written in a high level programming language. Compilers perform a variety of functions, such as syntax checking, generation of intermediate representations (IR), and generation of assembly instructions capable of operating on the native hardware. In addition to the compiler, other tools such as linkers, archivers, and debuggers may be used as part of the development process. As the demand for more powerful devices with reduced cost and improved portability continues, the development of new hardware platforms and corresponding software packages will continue to be vital.

### SUMMARY

Special-purpose hardware can be used in conjunction with general purpose processors to implement devices and products that are well-suited to tasks such as signal processing, communication, graphics rendering, encryption, transcoding, and image analysis, to name a few. Such products and devices typically require sophisticated software applications to implement the functionality. By performing technology mapping onto code fragments, a high-level application developer can focus on application development without getting overly immersed in details of the architecture of the special-purpose hardware.

A computer-implemented method for code implementation is disclosed comprising: obtaining a program description in a high level language; obtaining an intrinsic library of modules; determining a cut through the program description; matching a program fragment within the cut through the program description with a module in the intrinsic library; and replacing the program fragment with the module from the intrinsic library to produce an updated program description. Program descriptions are obtained in a high-level language. One or more intrinsic libraries containing modules are also obtained. The modules correspond to sections of code intended for execution on the special-purpose hardware. The high-level program description is analyzed to determine locations of one or more cuts within the program. The cuts represent portions of the high-level code that are eligible for replacement by one or more modules from intrinsic libraries. A matching process is used to find modules that are suitable replacements for the high-level code. Once the replacements are made, additional verification and/or validation may be performed by compiler checking and/or execution tests. The process results in code that is efficient with respect to power consumption and storage requirements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for technology mapping onto code fragments.

FIG. 2 is a flow diagram for cut usage.

FIG. 3 is example C code for analysis.

FIG. 4A and FIG. 4B illustrate an example intermediate representation.

FIG. 5 shows example library function calls.

FIG. 6 shows an example saturated add function.

FIG. 7 shows an example control data flow graph.

FIG. 8 is a flow diagram for matching a cut with an intrinsic call.

FIG. 9 shows a diagram of a system for technology mapping onto code fragments.

### DETAILED DESCRIPTION

Many computer systems are made up of a combination of general purpose processors along with special-purpose computing hardware. Throughout the electronics industry, improvements are being made to semiconductor chips and systems to improve many design parameters including chip size, speed, power consumption, heat dissipation, feature sets, and so on. Applications of these semiconductor chips and systems are primarily market-driven and include computation, digital communications, control and automation, etc. Digital signal processing and graphics processing are just two of the types of applications commonly in use.

The special-purpose hardware can include digital signal processors, graphics processing units, floating point processing units, and/or other special-purpose hardware. The special-purpose hardware can include entities such as circular buffers, null convention logic (NCL), cross-coupled inverters, and the like. Additionally, the special-purpose hardware can include complex structures such as storage circuits that can be read and written to in a pipelined manner, so that previously written data is being read from an output of the storage circuit as new data is being written to an input of the storage circuit.

While many of the improvements and the expanded capabilities have resulted from new and improved devices, circuit families, architectural techniques, and so on, the primary system customization technique continues to be coding of the applications. The applications coding is typically approached from the point of view of behavior and structure of the desired system, rather than physical system considerations such as the power dissipation and the storage requirements of the various instructions, subroutines, functions, etc., that make up the applications code. Thus, only after the development of successful software applications can the full value of specialized hardware be realized. This can involve teams of high-level programmers, software architects, and system engineers.

Applications code can be written using a variety of languages including assembly language, electronic design automation (EDA) languages, high-level languages, and so on. The code instructions, functions, subroutines, and so on are incorporated into the code by a linker, a compiler, etc., and provide the functionality required to implement the desired system. The applications code can include a program description. By analyzing the program description and by cutting and matching fragments of the high-level program description with modules from an intrinsic library, code that includes undesirable characteristics (such as instructions that lead to high power consumption or significant storage requirements) can be matched to and replaced by library functions that perform the same computational functions and reduce power and storage requirements. The replacement of the inefficient code segments with efficient library code segments can significantly improve system performance.

For a high-level programmer, the detailed knowledge of such hardware implementations can be an undue burden when attempting to develop sophisticated applications. The ability to perform technology mapping onto code fragments alleviates the need for high-level programmers to fully understand the details of the underlying special-purpose hardware architecture. Embodiments provide systems and methods for performing technology mapping onto code fragments. Sections in high-level code are identified. These sections, referred to as cuts, are replaced by intrinsic functions designed for the special-purpose hardware. The selection of the cuts, and the replacement with intrinsic functions, is automated by a computer-implemented system and method. Thus, the burden on high-level programmers is greatly reduced, allowing for more efficient software development with improved porting of code to multiple platforms.

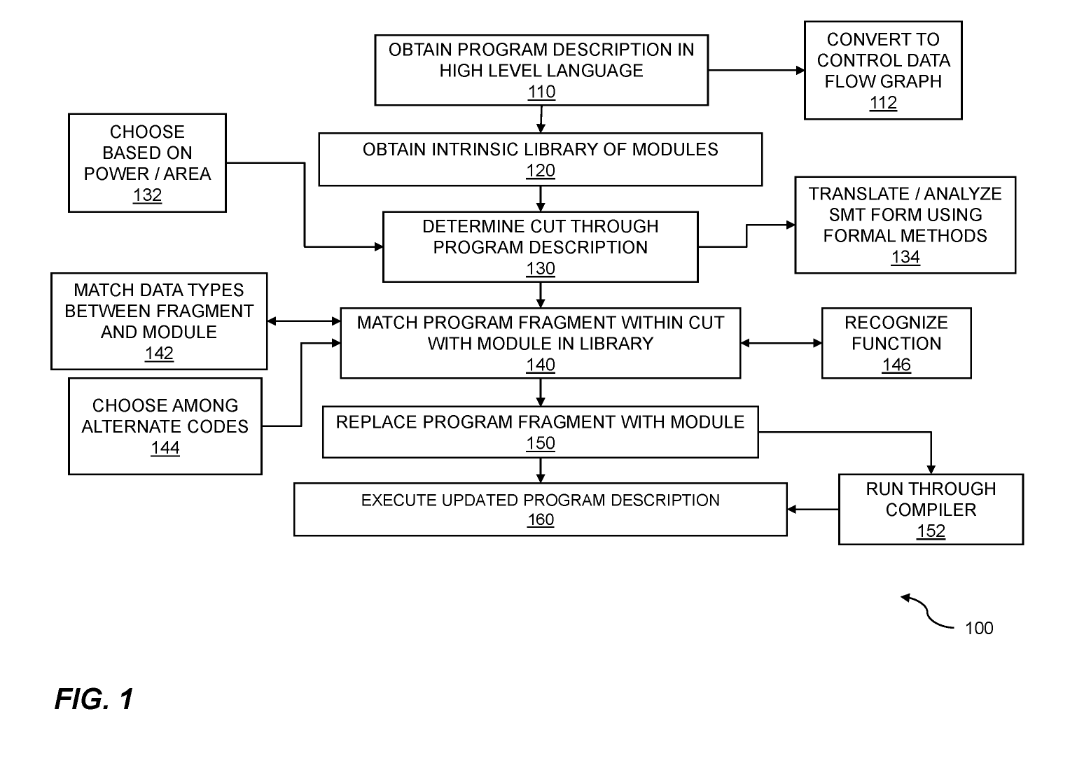

FIG. 1 is a flow diagram for technology mapping onto code fragments. The flow 100 begins with obtaining a program description in a high-level language 110. The program description can include programming language instructions, where the programming language instructions can include assembly code, EDA code, high-level code, and so on. In embodiments, the program description is implemented in C, C++, BASIC, Pascal, Python, Java, and/or another suitable high-level programming language. In some embodiments, assembly code is used inline within a program description written in a high-level language.

The flow 100 continues with obtaining an intrinsic library of modules 120. The intrinsic library of modules can comprise multiple functions that are designed to run on a mesh circuit that is comprised of a plurality of null convention logic (NCL) gates organized into rings. The hardware can also include a plurality of circular buffers coupled to processing elements. The circular buffers can store instructions that can be executed by processing elements. In embodiments, the intrinsic library includes intermediate representations, the intermediate representations describe subroutines, and the modules in the intrinsic library include intrinsic functions. The intrinsic functions can include, but are not limited to, a saturated add operation, a saturated subtract operation, and/or a signed-integer multiply and accumulate operation. Other functions can also include an instruction to double an integer and saturate, and then add to a second integer and saturate, and/or an instruction to double an integer and saturate, and then subtract from a second integer and saturate. Many other intrinsic functions are possible.

The flow 100 continues with determining a cut through the program description 130. A cut is a section of program description code that possibly is meant to be removed and replaced with an intrinsic function. In embodiments, modules in the intrinsic library include intrinsic functions that comprise subroutines for application functions. The cut can represent a section of code such as a subroutine, and/or a for loop, a while loop, a do-while loop, an if-then-else construct, or another section of code. The cuts to the program description can correspond to program fragments. The fragments can include various types of code including assembly code, EDA code, high-level code, and so on. The fragments can include instructions, functions, subroutines, etc. Thus, in embodiments, the program fragment includes assembly code. In embodiments, the assembly code includes a symbolic assembly language. A cut includes a group of connected instructions. Cuts could, for example, be generated by a labeling algorithm applied in topological order where labels are incremented as some threshold is reached. Instructions on the same label can belong to the same cut. A cut can be generated based on repeated Cartesian product of groups of instructions. Likewise, a cut can be generated based on a local search for instructions or instruction types. The flow 100 can include choosing a cut based on power/area 132. In embodiments, a cut is chosen based on power usage, area (hardware requirements), and/or performance. If power savings is the most important consideration of a design, then the cut can be placed to include fragments that can be implemented with lower power by using intrinsic functions. This might be the case in mobile applications that require battery power. If performance is the most important consideration of a design, then the cut can be placed to include fragments that can be implemented faster by using intrinsic functions. If area is the most important consideration of a design, then the cut can be placed to include fragments that can be implemented with fewer gates/registers by using intrinsic functions. Thus, in embodiments, the program fragment is chosen based on power and area consumption. In embodiments, the area required is estimated based on the number of instructions.

The flow 100 can include converting the program description to a control data flow graph 112. The control data flow graph (CFG) can be used as part of a cut location identification process. Part of the cut location identification process can include loop identification. The control data flow graph (CFG) can be used as part of a loop identification process. A control flow graph provides a map of code execution along with directional information. In embodiments, dominators are used as part of a loop identification process. Dominator trees can be constructed from the control data flow graph and back edges can be identified as part of the loop identification process. A dominator can be found when all paths to a given node have to go through another node. The identified loops can be candidates for cuts. The identified loops can be reducible loops or irreducible loops. In some embodiments, the analysis for cut placement is based on the high-level code of a program description or an intermediate representation. Thus, in some embodiments, the converting the program description to a control data flow graph is skipped. Alternatively, an abstract syntax tree (AST) can be generated instead of, or in addition to, a control data flow graph. The AST can be used for functions such as type checking. Additionally, in some embodiments, the AST is used in generation of an intermediate representation for the high-level program description.

The flow 100 continues with matching a program fragment within a cut with a module in a library 140. Thus, in embodiments, the matching includes recognizing a function in the program description which corresponds to a function in the intrinsic library. The matching can include multiple criteria. In embodiments, the input types and output types are checked and compared with functions within the intrinsic library to determine if any intrinsic functions have similar input and output types. The flow 100 can include matching data types between a fragment and a module 142. Intrinsic functions that have similar input and output types can be deemed eligible for a second pass of match evaluation. For example, if a cut in the program description contains a fragment comprising a function that accepts two integers as inputs and outputs, then intrinsic functions that have similar inputs and outputs can be deemed as eligible for a second pass of match evaluation. Conversely, as part of the same example, an intrinsic function that accepts three floating point numbers as inputs can be deemed ineligible. Similarly, as part of the same example, an intrinsic function that outputs an array of characters can be deemed ineligible. Thus, in embodiments, the matching is based on matching data types between the program fragment and the module within the intrinsic library.

In some embodiments, the data types include, but are not limited to, a signed character, an unsigned character, a signed integer, an unsigned integer, a signed short, an unsigned short, a signed long, an unsigned long, a float, a double, and/or a long double. The size of these data types can vary based on the specific architecture of the underlying hardware. In some embodiments, a character is one byte, a short is two bytes, and an integer is four bytes. Furthermore, the floating point types can be implemented such that a float is four bytes, a double is eight bytes, and a long double is 10 bytes. With these data sizes, the signed character has a range from −128 to 127; the signed short has a range from −32,768 to 32,767; and the signed long has a range from −2,147,483,648 to 2,147,483,647.

A second pass of match evaluation can include examining functionality within the fragment. For example, if the fragment performs an addition of two input values, then intrinsic functions that meet the input/output criteria and also perform the addition can be selected as a match for the fragment. In embodiments, additional criteria is evaluated in multiple passes.

The matching can include recognizing a function in the program description that corresponds to a function in the intrinsic library. For example, a function in the program can include a DSP operation that corresponds to a similar DSP operation in the library. The matching can include using satisfiability modulo theories (SMT) algebraic expressions. Thus, in embodiments, algebraic expressions from the program description are based on satisfiability modulo theories (SMT). The flow 100 can include translation of algebraic expressions to SMT form and analysis of the SMT form using formal methods 134. Thus, embodiments include analyzing the SMT form using formal methods. The formal methods can include conversion of a decision problem into a logical equivalent using, for example, propositional conjunctive normal form. The formal methods can utilize atomic formulas, quantifier free formulas (QFFs), first-order formulas, and sentences. The SMT algebraic expressions can be part of the algebraic expressions from the program description and can result from translation of the algebraic expressions from the program description into SMT form. The SMT techniques can be used to evaluate predicates comprising a binary-valued function of non-binary values. Using an SMT solver, conditions within the code can be checked for satisfiability. Thus, in embodiments, assembly code is translated into SMT form. As stated previously, the assembly code can include a symbolic assembly language. In embodiments, the symbolic assembly language includes assertions. The assertions can be used to validate certain program parameters and/or conditions. An example of such a symbolic assembly language including assertions is shown below:

(declare-const alpha Bool)
(declare-const bravo Bool)
(declare-const charlie Bool)
(declare-const delta Bool)
(assert (=> alpha charlie)); alpha charlie relationship
(assert (=> bravo delta)); bravo delta relationship
(assert alpha); alpha status

There can be more than one module or intrinsic function that can serve as a replacement. The flow 100 can include choosing among alternate codes 144. In embodiments, a code (module or intrinsic function) is chosen based on design criteria. If performance is the most important consideration of a design, then the selected code can include intrinsic functions that can be implemented faster than high-level code. If area is the most important consideration of a design, then the selected code can include intrinsic functions that can be implemented with fewer gates/registers than high-level code. If power savings is the most important consideration of a design, then the selected code can include intrinsic functions that can be implemented with lower power consumption than high-level code. In embodiments, the selection of intrinsic functions that save power is performed using a non-greedy optimizer which explores the combination of matches to yield a program with lowest power. Thus, embodiments include choosing among alternative coding realizations. The choices can correspond to different matches with different schedules. The choice covering, performed under the control of an optimizer, can select the best combination of choices to realize the program, thereby simultaneously solving the selection and scheduling. In embodiments, estimated power consumption is computed by executing the computer program in an interpreter and counting routine invocation frequency. The flow 100 can include recognizing a function 146. A match determination can be made based on function recognition. For example, if an adder is recognized in the high-level program description, then that function can be replaced by an adder intrinsic function.

The flow 100 continues with replacing a program fragment with a module 150. The module used for replacement is the module identified as a match as described via callout 140. The program fragment with the replacement module is a modified program fragment. The replacement can be implemented as a macro that calls the module from the intrinsic library. The module can be optimized for execution on hardware comprising circular buffers. In embodiments, the intrinsic functions include special-purpose sub-routines for implementing operations on a reconfigurable fabric hardware. In some embodiments, the fabric includes multiple switches configured into a network such as a mesh. The switches can be configured in a grid-like pattern, where each switch is connected to an adjacent neighbor on a North, South, East, and West side.

The flow 100 can continue with running the updated program description that includes the modified program fragment through a compiler 152. Thus, in embodiments, the updated program description is run through a C compiler to validate the results of the replacing the program fragment. The compiler can perform a lexical analysis, a syntax check, and/or a semantic check. Upon successful running through the compiler, the flow continues with executing the updated program description 160. Thus, embodiments include executing the updated program description to validate the results of the replacing the program fragment. During execution, the updated program description can be tested with a variety of inputs and outputs to confirm proper operation under all circumstances. Optionally, the flow can continue from replacing a program fragment with a module 150 to execution of the updated program description 160 without running the updated program description through the compiler, thus skipping 152. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

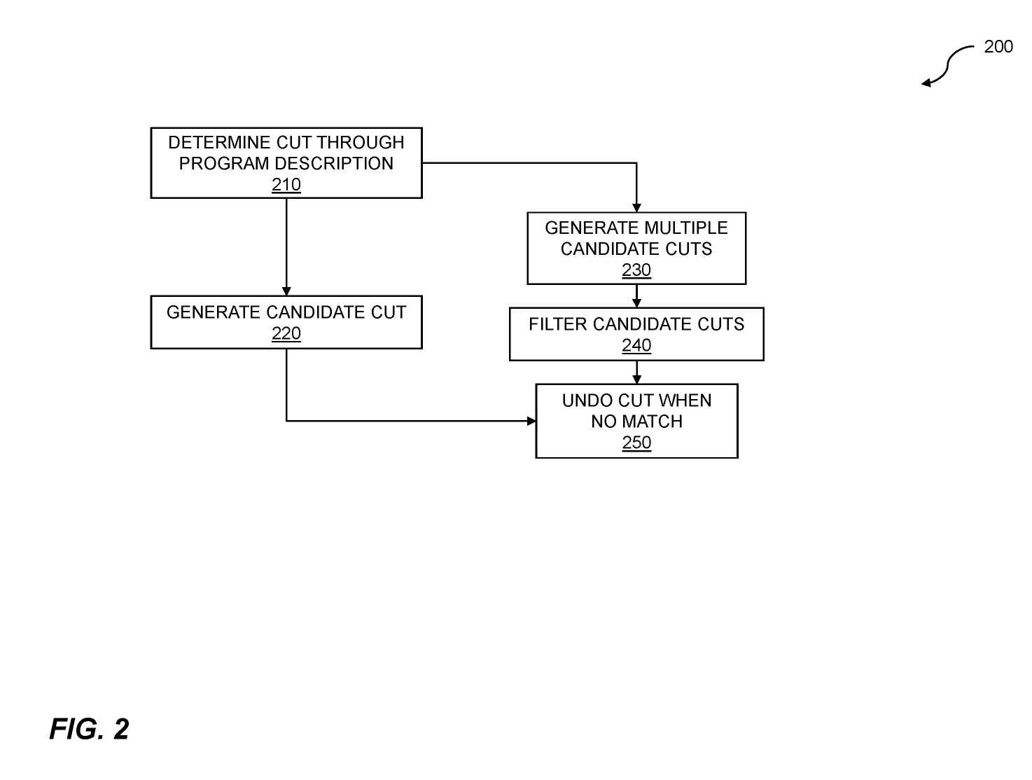

FIG. 2 is a flow diagram 200 for cut usage. The flow 200 starts with determining a cut through the program description 210. This can include identification of loops, if-then-else constructs, and other sections of the high-level code. The high-level code can be implemented in C, C++, Lisp, Python, or another suitable language. In some embodiments, the high-level language includes C code. Furthermore, in some embodiments, the intrinsic library includes C code. ANSI C is a frequently used high-level language for embedded software development, but it is not always the best language for special-purpose tasks. For example, it lacks ways to specify various types of computations that are specific to digital signal processing. Therefore, typically a compiler by itself is often unable to generate efficient machine code. Within the high-level program description, a reference to an intrinsic function might have the appearance of a macro call or function call in C source code. However, the macro is replaced by a sequence of lower-level instructions intended for execution on the special-purpose hardware.

The intrinsic substitution provides considerable performance benefits. Since the intrinsic instruction or instructions are more efficient than the sequence of instructions generated by the original high-level program description, there is a reduction in both instruction and cycle counts. This means less fetching, decoding, and execution cycles. Additionally, with inline expansion, function call overhead is eliminated. The savings can be compounded in code constructs that utilize iteration, such as “for” loops. The flow 200 can continue with generating a candidate cut 220. The candidate cut defines one or more fragments that can be eligible for replacement by an intrinsic function. If, based on criteria such as type identification and functionality, no suitable module is found for replacement, then the flow continues to undo the cut when there is no match 250. Thus, in embodiments, determining the cut comprises generating a candidate cut.

Alternatively, the flow 200 can include generating multiple candidate cuts 230. Thus, in some embodiments, determining the cut comprises generating a plurality of candidate cuts. The flow 200 then continues to filtering of the candidate cuts 240. The filtering of the candidate cuts can include evaluation of design preferences such as power consumption, area requirements, and so on. Thus, embodiments include filtering the plurality of candidate cuts to look for a match to a module in the intrinsic library. If, based on criteria such as type identification and functionality, no suitable module is found for replacement, then the flow continues to undo the cut when there is no match 250. Thus, embodiments include undoing the cut that was determined when no match is found to a module in the intrinsic library. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

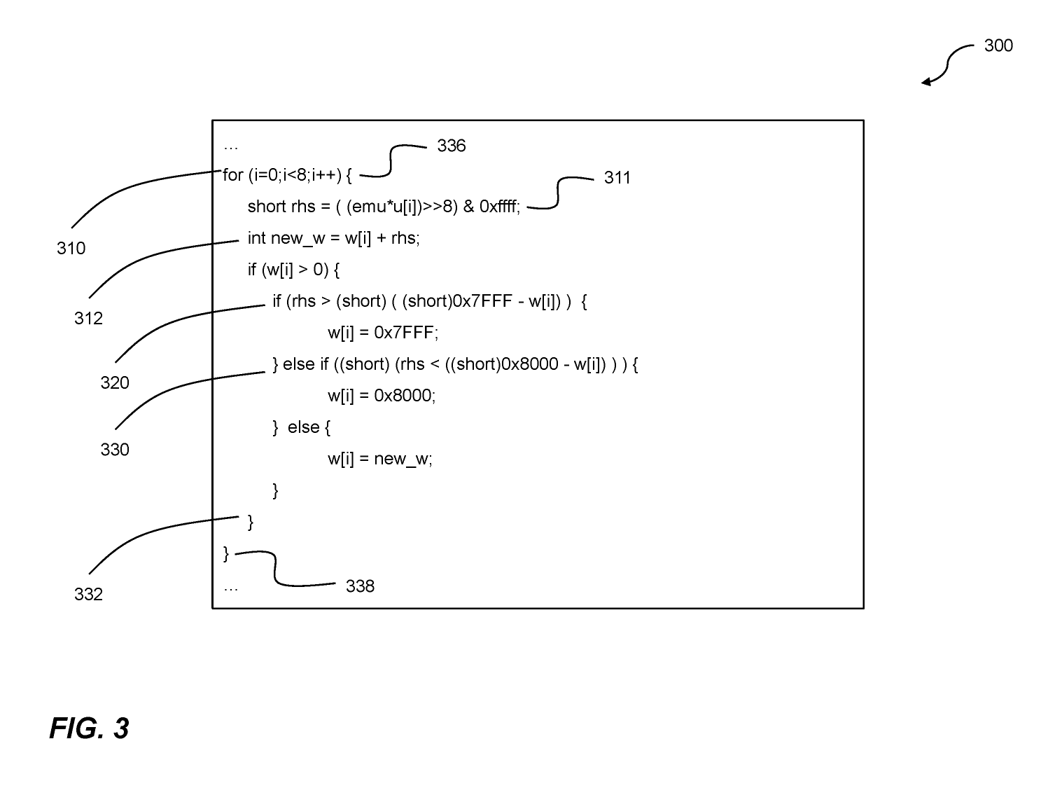

FIG. 3 is example C code for analysis. The example 300 represents an excerpt of code within a larger program and includes some saturating add functionality within a for loop. The example includes a for loop 310 that iterates eight times. Within the for loop 310, a saturated add is performed on multiple values within an array. Saturation arithmetic is arithmetic that includes minimum and maximum values for arithmetic operations, instead of wrapping around, as in the case with conventional modular arithmetic. Thus, when the result exceeds the data size limitation (e.g. a 17 bit value in a 16-bit architecture), saturation arithmetic provides a value that is as close as possible to the true value. This has benefits in various applications including digital signal processing, where saturation causes considerably less distortion than the wrap-around effect of modular arithmetic. Thus, in embodiments, the intrinsic library comprises subroutines corresponding to digital signal processing instructions. Furthermore, in embodiments, the digital signal processing instructions include saturated arithmetic operations.

Referring again to example 300, line 311 computes a variable rhs as a function of multiplication and logical shifting. An intermediate value new_w is computed at line 312. The variable rhs is checked for a maximum positive saturation limit at line 320 and is checked for a minimum (negative) saturation limit at line 330. The example 300 represents 16-bit saturated addition. Thus, the maximum positive value is 0x7FFF, and the minimum (most negative) value is 0x8000. In C code, curly braces (indicated generally as 332) can be used to indicate a block of code. Code constructs can include, but are not limited to, for loops, while loops, do—while loops, if clauses, else clauses, and if—then—else clauses. In embodiments, candidate cuts are performed at one or more curly brace locations. For example, a candidate cut can be performed on the code between the curly brace 336 and the curly brace 338. In some embodiments, the functionality within a loop is expanded as individual inline functions corresponding to the number of iterations in the loop. Thus, in this example, since the for loop 310 iterates 8 times, the replacement code for the cut can include 8 instances of an inline intrinsic function.

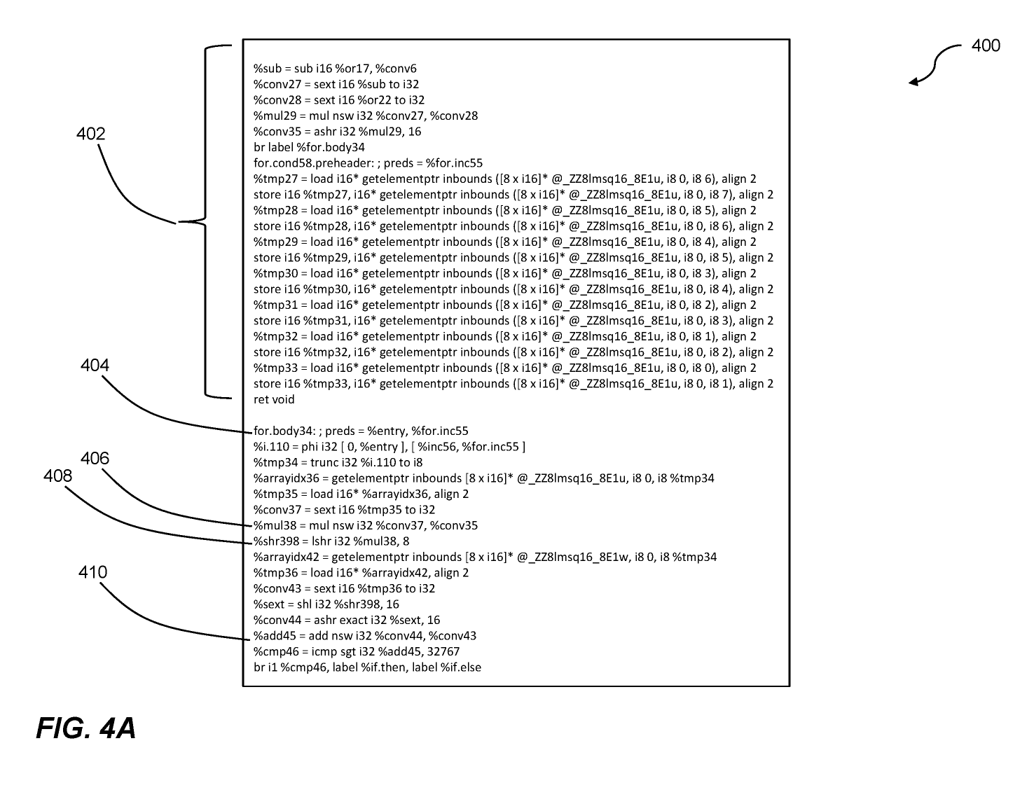

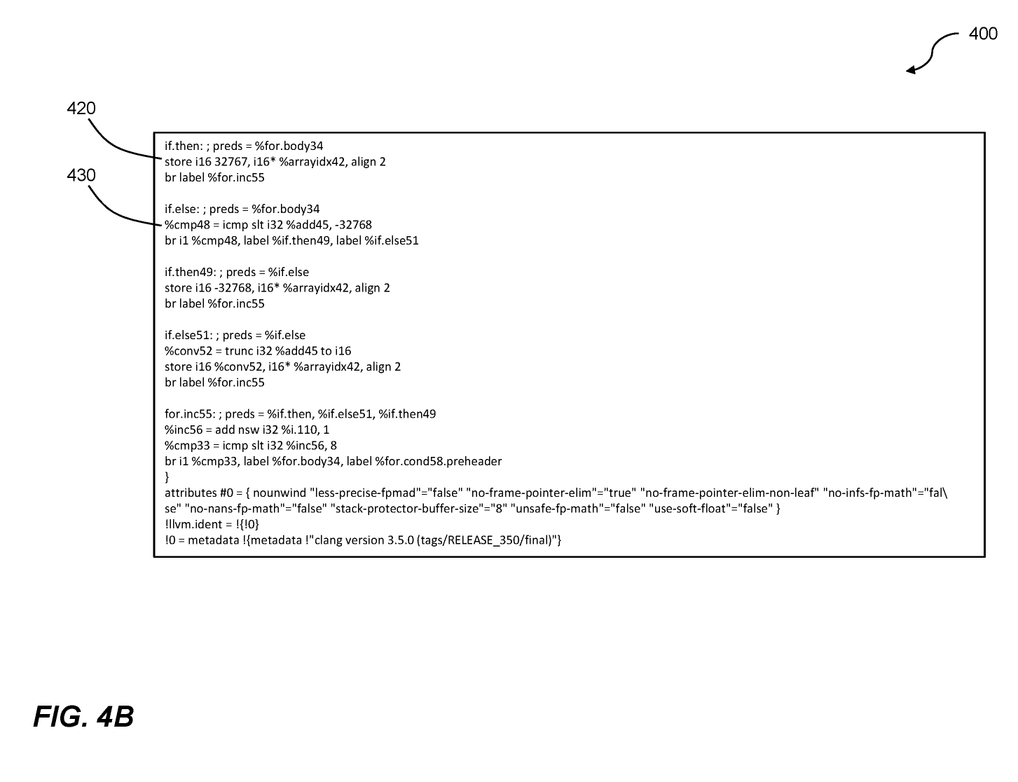

FIG. 4A and FIG. 4B illustrate an example intermediate representation 400. In embodiments, the intermediate representation is in assembly language corresponding to the code of FIG. 3. In other embodiments, the intermediate representation is in a compiler-based architecture-independent intermediate representation. In some embodiments, the intermediate representation is an LLVM intermediate representation. LLVM is a toolchain of components for compilation of code. The LLVM toolchain includes a font end, an optimizer and a backend. The front end is used for parsing high-level source code. The source code can be in a variety of high-level languages, including, but not limited to, C, C++, Python, Fortran, Ada, or another suitable high-level language. The backend generates target-specific information such as instruction selection, instruction scheduling, and/or register allocation. The optimizer performs transformations in an effort to reduce execution time. This can include techniques such as eliminating redundant computations.

The LLVM intermediate representation can be in a human-readable format, a C++ object format, or a bitcode format. LLVM intermediate representation provides a low-level RISC-like virtual instruction set. Similar to a real RISC instruction set, it supports linear sequences of simple instructions such as add, subtract, compare, and branch. The instructions can accept some number of inputs and produce a result in a different register. The intermediate representation 400 illustrates an example in LLVM human-readable format.

Section 402 is an initialization section to set up values of variables and/or registers. Line 404 indicates the start of a for loop construct. Line 406 indicates a multiplication function, and line 408 indicates a shift right function. Thus, it can be seen that lines 406 and 408 implement the functionality of line 311 in the high-level program description (FIG. 3). Line 410 indicates an addition, and line 420 of FIG. 4B indicates storing a maximum value for a 16-bit saturated add. Similarly, line 430 indicates storing a minimum value for a 16-bit saturated add.

One advantage of performing replacements with modules from an intrinsic library based on a symbolic intermediate representation is that it facilitates portability to alternative hardware platforms. The symbolic intermediate representation can be hardware independent. The target hardware can be changed with little or no modification to the macros used in the substitutions. Thus, code that is tested and mature can often be reused for different hardware platforms. The ability to prepare code for different hardware platforms without modifying the macros that enable the intrinsic substitutions provides a considerable benefit to a high-level programmer working on applications that include special-function hardware. Namely, it allows development on multiple hardware platforms concurrently and can also facilitate improved code reusability.

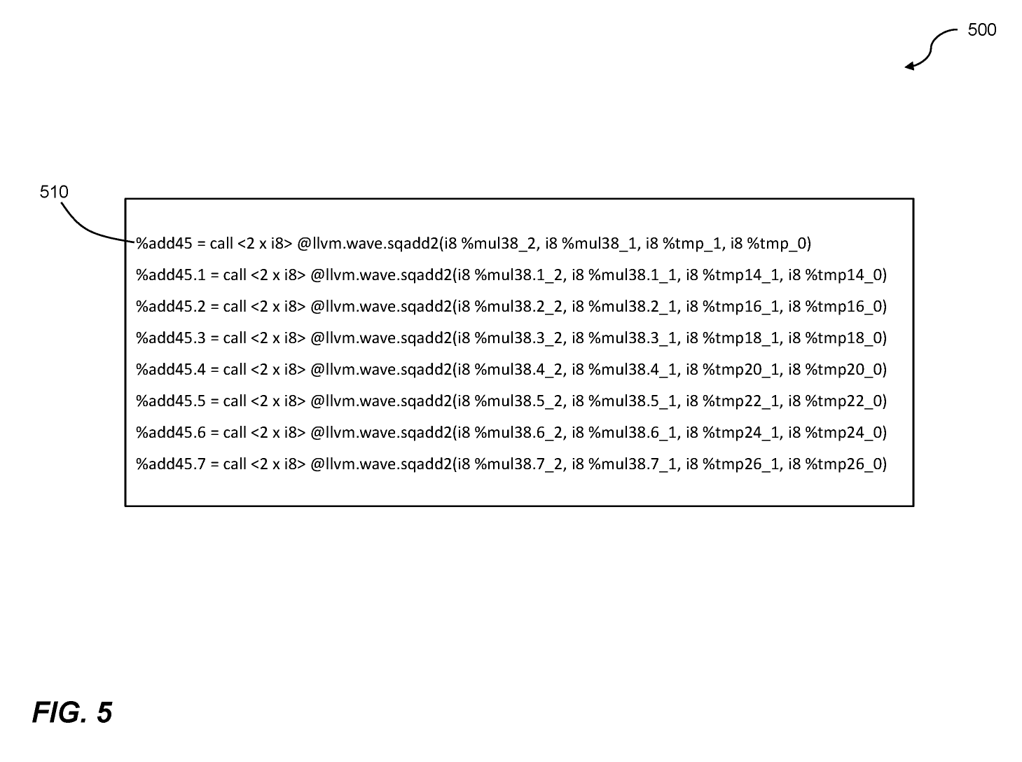

FIG. 5 shows example library function calls. The example 500 includes eight macro calls as a result of matching, of which line 510 is an example macro call. The eight macro calls correspond to the eight iterations specified by the for loop 310 that iterates eight times. Thus, the high-level program description fragment is replaced by the macro calls shown in example 500. Each macro call of sqadd2 represents an intrinsic function for a 16-bit saturated add operation. Referring again to FIG. 3, the high-level program description includes operations that utilize multiple basic blocks. Basic blocks can include, but are not limited to, add operations, shift operations, and various logic operations. In embodiments, the cut spans multiple basic blocks of the program description.

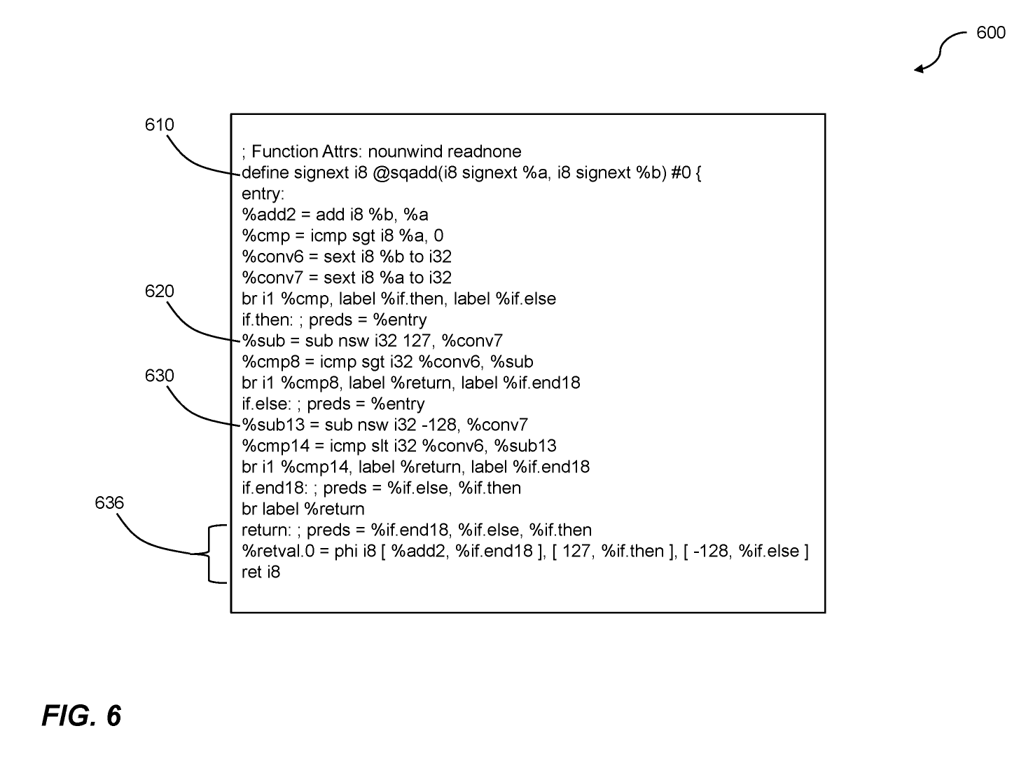

FIG. 6 shows another example saturated add function. In this case, the diagram 600 shows an 8-bit saturated add function and includes the LLCM intermediate representation. Line 610 shows the function definition. Line 620 shows the clamping of the output to a maximum value of 127 if the output exceeds that value. Line 630 shows the clamping of the output to a minimum value of −128 if the output falls below that value. The return section 636 returns the output that is either the actual value if it is within the upper and lower limits, or alternatively, it returns the upper or lower limit value if the actual value is outside of those limits.

In embodiments, an intrinsic library contains many modules/functions such as the function shown in FIG. 6. During a cut/replace operation, high-level program description fragments are replaced with macros that invoke functions such as that shown in FIG. 6. In some embodiments, multiple intrinsic libraries are included, where each of the multiple intrinsic libraries supports a different hardware platform. Thus, there can be multiple 8-bit saturated add functions, each callable with a different macro. Depending on the desired target hardware, embodiments replace the high-level program fragment with the appropriate macro for the target hardware.

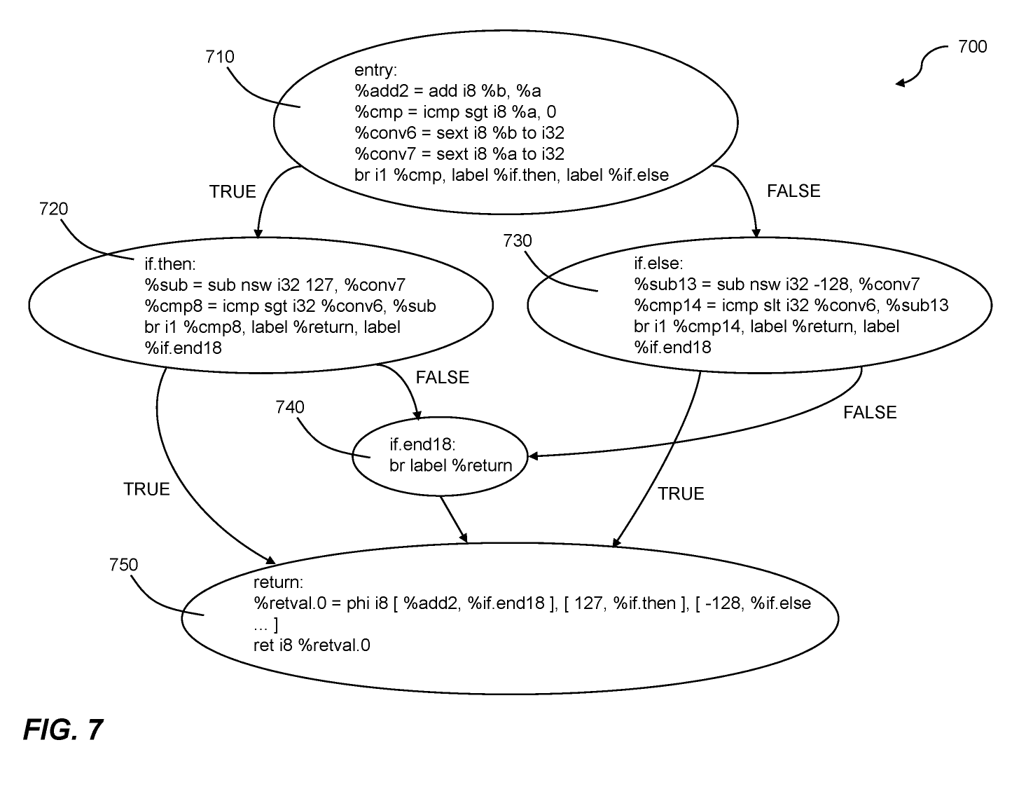

FIG. 7 shows an example control data flow graph 700. The control data flow graph 700 is a representation of the 8-bit saturated add function shown in FIG. 6. Node 740 contains the entry to the function, including the comparison to check if the output value is positive or negative. If the value is negative, the flow continues to node 730, where a check is made to see if the output value is outside of the lower limit value of −128. If it is not outside the value, the flow continues back to node 740, and then to node 750 for returning of the result. If the output value is below the lower limit, indicating a negative overflow, then at node 750, the lower limit of −128 is returned. Similarly, if evaluation at node 710 indicates a positive output value, then the flow continues to node 720, where a check is made to see if the output value is outside of the upper limit value of 127, indicating a positive overflow. Depending on the evaluation, the flow continues to node 740 and/or node 750 for returning an output value that is either the actual value, the lower limit value (−128), or the upper limit value (127), thus providing an 8-bit saturated add function. In some embodiments, once overflow has been detected, based on an overflow output, an instruction retrieves the most positive or most negative allowable value from a register, depending on whether the overflow was negative or positive.

Some embodiments include converting the program description in the high-level language into a control data flow graph. In such embodiments, determining the cut through the program description is based on the control data flow graph. While the example shown in FIG. 7 represents a control flow diagram of an intrinsic function, in other embodiments, the control data flow graph represents a plurality of program fragment types in the high-level language. The analysis of where to make cuts and/or candidate cuts can be made using the control data flow graph which represents a plurality of program fragment types in the high-level language. The plurality of program fragment types can provide differing representations for similar operations. For example, there can be multiple ways to implement a saturated add function in a high-level language, and each of those implementations may map to, and be replaced by, one or more macro calls to the same intrinsic function(s).

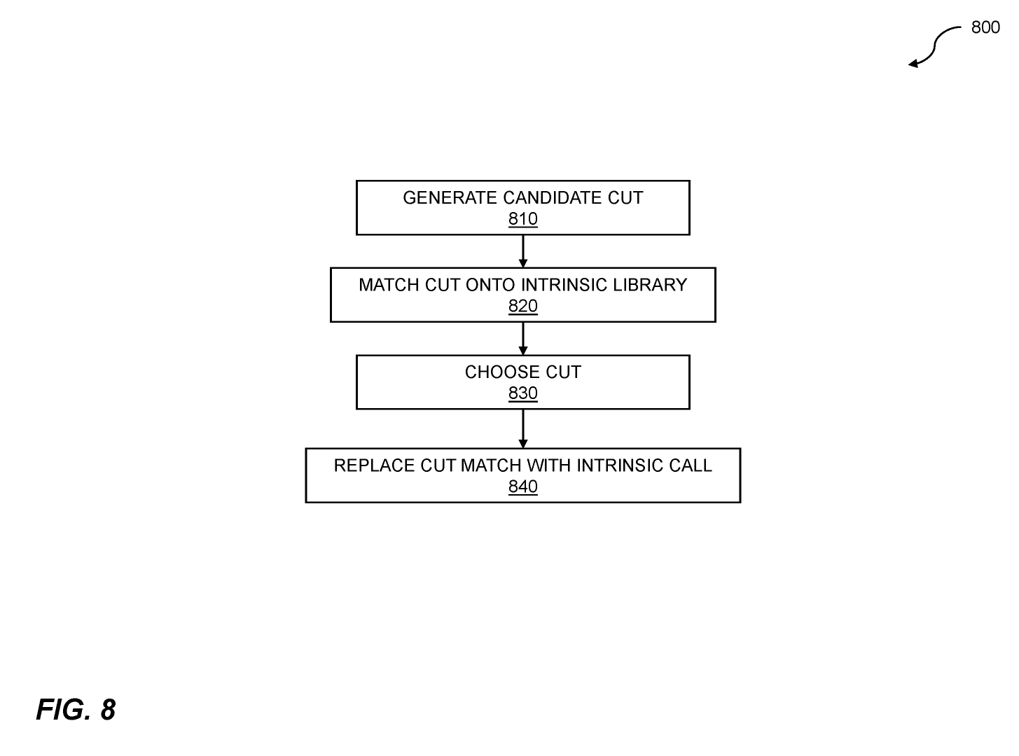

FIG. 8 is a flow diagram 800 for matching a cut with an intrinsic call. The flow starts with generating a candidate cut 810. The candidate cut defines one or more fragments that can be eligible for replacement by an intrinsic function. The candidate cut can be identified by analyzing the high-level program description to find code constructs such as loops, add operations, shift operations, multiply operations, and other code constructs. The flow continues with matching a cut onto the intrinsic library 820. In some embodiments, the largest candidate cut is chosen first, and if no match is found for that candidate cut, then the second largest candidate cut is selected, and so on, until a candidate cut is found that matches. In this way, embodiments attempt to replace as much code as possible with intrinsic library functions, thereby maximizing the benefits of special purpose hardware. The code continues with choosing a cut 830. In embodiments, the chosen cut is the largest cut for which a match is found. The size of the cut can be determined based on inline expansion. Thus, a cut that contains a loop with a few lines of code that iterates many times can be evaluated as a large cut. The flow then continues with replacing the cut match with an intrinsic call 840. In embodiments, semantic matching is used. For example, a multiplier routine might be expressed as a repeated addition to save power. To implement this, embodiments automatically find the match of a multiplier in the program description with the multiplier in the intrinsic library because they implement the same functionality, although written in different ways. Various steps in the flow 800 may be changed in order, repeated, omitted, or the like without departing from the disclosed concepts. Various embodiments of the flow 800 can be included in a computer program product embodied in a non-transitory computer readable medium that includes code executable by one or more processors.

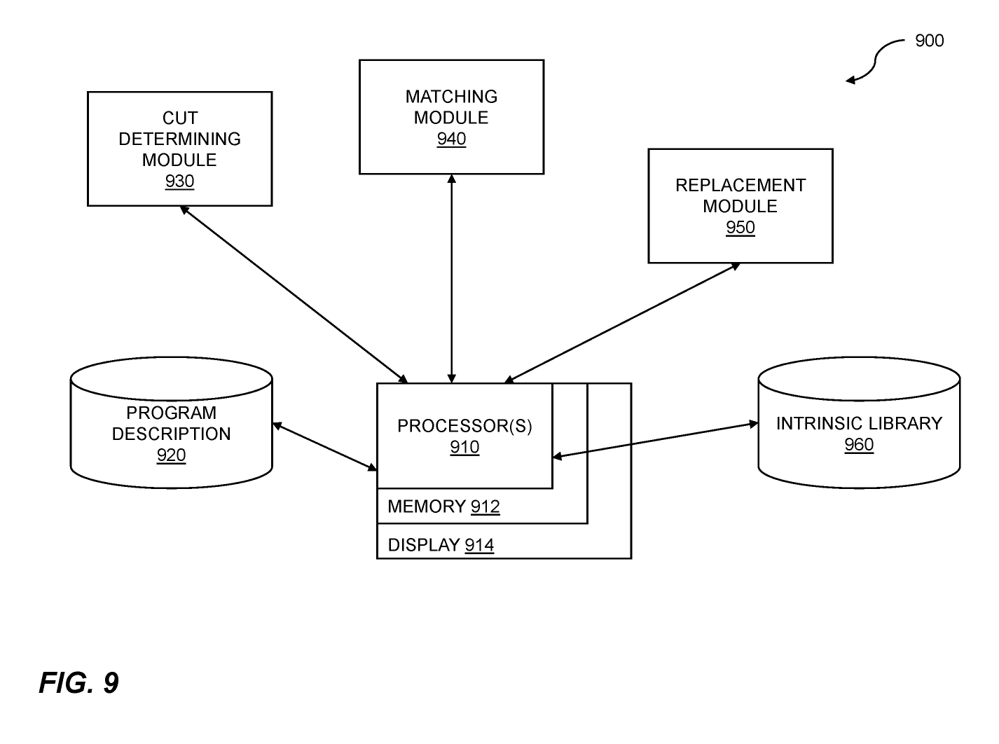

FIG. 9 is a system for technology mapping onto code fragments. The system 900 can include one or more processors 910 which are coupled to a memory 912. The memory 912 can be used for storing instructions, for storing program descriptions, for storing sub-routines of functions, for system support, for help information, and the like. The memory can contain code data in a data format used for the exchange of program data (e.g. information stored in assembly language format, electronic design automation (EDA) format, or any other suitable format for storing program data). The one or more processors 910 can read in information regarding program descriptions 920 including instruction graphs and information regarding intrinsic functions from an intrinsic library 960. The processors 910 can generate cuts corresponding to program fragments using the cut determining module 930. The processors 910 can match program fragments to the cuts with functions from the intrinsic library 960 using the matching module 940. The processors 910 can replace the cuts in the program description with replacement code including macros to call intrinsic functions by using the replacement module 950. The program descriptions 920 can be represented in the form of digital data stored on a physical storage medium such has a hard disk drive (HDD), a solid state drive (SSD), and so on. The digital data can be in the form of a library, a database, etc. Similarly, the functions within intrinsic library 960 can be represented in the form of digital data and stored on a physical storage medium such as a hard drive, solid state drive, etc. The collection of intrinsic functions can also be in the form of a library, a database, and so on. In at least one embodiment, the cut determining module 930, the matching module 940, and the replacement module 950 functions are accomplished by the one or more processors 910.

In embodiments, one or more of the program descriptions 920, cut determining module 930, matching module 940, replacement module 950, and intrinsic library 960 are interconnected via the Internet. Cloud computing can be used to generate cuts to the instruction graph, to match program fragments to the cuts with the library, and to rewrite cuts with the program fragments. Information about the various designs can be shown on a display 914 which can be attached to the one or more processors 910. The display 914 can be any electronic display, including but not limited to, a computer display, a laptop screen, a net-book screen, a tablet screen, a cell phone display, a mobile device display, a remote with a display, a television, a projector, and the like.

The system 900 provides for a computer-implemented method for code implementation comprising: obtaining a program description in a high-level language; obtaining an intrinsic library of modules; determining a cut through the program description; matching a program fragment within the cut through the program description with a module in the intrinsic library; and replacing the program fragment with the module from the intrinsic library to produce an updated program description. The system 900 can include a computer program product embodied in a non-transitory computer readable medium for coding implementation, the computer program product comprising: code for obtaining a program description in a high-level language; code for obtaining an intrinsic library of modules; code for determining a cut through the program description; code for matching a program fragment within the cut through the program description with a module in the intrinsic library; and code for replacing the program fragment with the module from the intrinsic library to produce an updated program description.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system” —may be implemented by computer program instructions, by special-purpose hardware-based computer systems, by combinations of special purpose hardware and computer instructions, by combinations of general purpose hardware and computer instructions, and so on. In some embodiments, the special-purpose hardware may include a combination of asynchronous and synchronous circuits, where data and/or control information is passed between the asynchronous circuits and synchronous circuits via an interface.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for code implementation comprising:
obtaining a program description in a high level language;
obtaining an intrinsic library of modules;
determining a cut through the program description;
matching a program fragment within the cut through the program description with a module in the intrinsic library; and
replacing the program fragment with the module from the intrinsic library to produce an updated program description.

2. The method of claim 1 wherein the intrinsic library includes intermediate representations.

3. The method of claim 2 wherein the intermediate representations describe subroutines.

4. The method of claim 1 wherein the modules in the intrinsic library include intrinsic functions.

5. The method of claim 4 wherein the intrinsic functions include special-purpose sub-routines for implementing operations on a reconfigurable fabric hardware.

6. The method of claim 1 wherein the matching is based on matching data types between the program fragment and the module within the intrinsic library.

7. The method of claim 1 further comprising converting the program description in the high level language into a control data flow graph.

8. The method of claim 7 wherein the determining the cut through the program description is based on the control data flow graph.

9. The method of claim 7 wherein the control data flow graph represents a plurality of program fragment types in the high level language.

10. The method of claim 9 wherein the plurality of program fragment types provides differing representations for similar operations.

11. The method of claim 1 wherein the high level language includes C code.

12. The method of claim 11 wherein the intrinsic library includes C code.

13. The method of claim 12 wherein the updated program description is run through a C compiler to validate results of the replacing the program fragment.

14. The method of claim 13 further comprising executing the updated program description to validate the results of the replacing the program fragment.

15. The method of claim 1 wherein the determining the cut comprises generating a candidate cut.

16. The method of claim 1 wherein the determining the cut comprises generating a plurality of candidate cuts.

17. The method of claim 16 further comprising filtering the plurality of candidate cuts to look for a match to a module in the intrinsic library.

18. The method of claim 17 further comprising undoing the cut that was determined when no match is found to a module in the intrinsic library.

19. The method of claim 1 wherein the modules in the intrinsic library include intrinsic functions that comprise subroutines for application functions.

20. The method of claim 19 further comprising choosing among alternative coding realizations.

21. The method of claim 1 wherein the intrinsic library comprises subroutines corresponding to digital signal processing instructions.

22. (canceled)

23. The method of claim 1 wherein the matching includes recognizing a function in the program description which corresponds to a function in the intrinsic library.

24. (canceled)

25. The method of claim 1 wherein the cut spans multiple basic blocks of the program description.

26. The method of claim 1 wherein the program fragment is chosen based on power and area consumption.

27. The method of claim 1 wherein the program fragment includes assembly code.

28. The method of claim 27 wherein the assembly code is translated into SMT form.

29. The method of claim 28 further comprising analyzing the SMT form using formal methods.

30-31. (canceled)

32. A computer program product embodied in a non-transitory computer readable medium for coding implementation, the computer program product comprising:
code for obtaining a program description in a high level language;
code for obtaining an intrinsic library of modules;
code for determining a cut through the program description;
code for matching a program fragment within the cut through the program description with a module in the intrinsic library; and
code for replacing the program fragment with the module from the intrinsic library to produce an updated program description.

33. A computer system for coding implementation comprising:
a memory which stores instructions;
one or more processors coupled to the memory wherein the one or more
processors, when executing the instructions which are stored, are configured to:
obtain a program description in a high level language;
obtain an intrinsic library of modules;
determine a cut through the program description;
match a program fragment within the cut through the program description with a module in the intrinsic library; and
replace the program fragment with the module from the intrinsic library to produce an updated program description.
